(19) United States
(12) Patent Application Publication
(10) Pub. No.: US 2001/0041779 A1
(43) Pub. Date: Nov. 15, 2001

(54) PROCESS FOR MANUFACTURING POLYETHYLENE WITH A FUNCTIONAL END GROUP IN THE PRESENCE OF METALLOCENE CATALYST

(76) Inventors: DONG GEUN SHIN, DAEJEON (KR); DOO JIN BYUN, DAEJEON (KR); SANG YOUL KIM, DAEJEON (KR)

Correspondence Address: WHITHAM CURTIS & WHITHAM, RESTON INTERNATIONAL CENTER, 11800 SUNRISE VALLEY DRIVE STE 900, RESTON, VA, 20191

(21) Appl. No.: 09/340,054

(22) Filed: Jun. 28, 1999

(30) Foreign Application Priority Data
Sep. 18, 1998 (KR) 98-38798

(51) Int. Cl. C08F 4/44

(52) U.S. Cl. 526/160; 526/943; 526/348.2; 526/348.3; 526/348.5; 526/348.6; 526/335; 526/336; 526/346; 526/282; 526/352

(57) ABSTRACT

The present invention relates to a process for manufacturing polyethylene with a functional end group in the presence of metallocene catalyst and more particularly, to the process for manufacturing polyethylene with a functional end group in such a manner that a highly reactive functional group of alkyl-aluminum is easily introduced to the end of polymer via a selective chain transfer reaction in the presence of (1) metallocene catalyst represented by the following formula 1 and (2) a cocatalyst containing alkyl-aluminum compound as active ingredient.

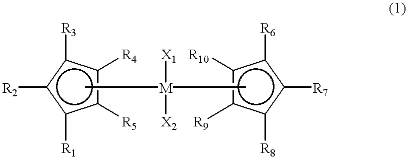

### BACKGROUND OF THE INVENTION

1. Field of the Invention

The present invention relates to a process for manufacturing polyethylene with a functional end group in the presence of metallocene catalyst and more particularly, to the process for manufacturing polyethylene with a functional end group in such a manner that a highly reactive functional group of alkyl-aluminum is easily introduced to the end of polymer via a selective chain transfer reaction in the presence of (1) metallocene catalyst represented by the following formula 1 and (2) a co-catalyst containing alkyl-aluminum compound as an active ingredient.

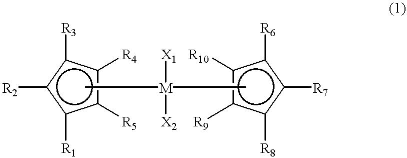

Where, M is a transition metal atom selected from Group IVB of the periodic table; R₁, R₂, R₃, R₄, R₅, R₆, R₇, R₈, R₉, and R₁ which are same or different, are a hydrogen atom or an alkyl group of 1 to 12 carbon atoms; at least two substituents should contain an alkyl group of 1 to 12 carbon atoms instead of a hydrogen atom; one or more substituents may be combined each other; X₁ and X₂, which are same or different, are a ligand except for a non-cyclopentadienyl ligand, representing such as an alkyl group of 1 to 12 carbon atoms, an alkoxy group of 1 to 6 carbon atoms, an amine group, a halogen atom, or hydrogen atom.

2. Description of the Related Art

Currently, any reactive functional group cannot be easily introduced to polyolefin due to its chemically stable structure in an organic reaction. Under such circumstances, intensive efforts to introduce any polar functional group to polyolefin have been made for a long period of time as an important polyolefin research subject.

The method for introducing some functional groups to polyolefin is largely divided into the followings: (1) a method to introduce a functional group to the main chain of polymers and (2) a method to introduce a functional group to the terminal chain of polymers. The method for introducing a functional group to the main chain of polymers has been applied hitherto so as to overcome several shortcomings associated with the chemical structure of polyolefin having nonpolar groups only, poor adhesive or sticking property, poor comparability to other plastic resins such as nylon, and lack of reactivity in the chemical reaction such as graft copolymerization. On the other hand, the method for introducing a functional group to the terminal chain of polymers is useful for preparing a graft or block copolymer, and may be effectively used as an intermediate of functional polymers which serve to introduce a functional additive or group to the terminal chain of polymers.

A typical method for manufacturing the polyolefin with the functional end has been disclosed in the Korea Laid-open Patent No. 97-707174. This method is to utilize the termination reaction under a common polymerization in the presence of Ziegler-Natta catalyst, where an alkyl group is predominantly transferred to aluminum. However, based on the typical polymerization conditions of heterogeneous Ziegler-Natta catalyst, this method cannot show any properties of polyolefin prepared by metallocene catalyst, and cannot be applied to olefin polymerization using a homogeneous catalyst. Furthermore, this method has several disadvantages in that (1) the homogeneity of polyolefin, so formed, cannot be secured, especially on the homogeneity of molecular weight, incorporation content and distribution of comonomer in the copolymers, (2) the incorporation content of bulky comonomer in the copolymers cannot be enhanced due to its larger steric hindrance effect, and (3) this method cannot be applied to a polymerization system using metallocene catalysts which may be widely employed as a catalyst for polyolefins in the future.

In this context, many researches have focused on the manufacture of polyolefin with functional end using metallocene or a homogeneous Ziegler-Natta catalyst in the academic and industrial field.

So far, the method for introducing a functional group to the terminal chain has been mainly studied by several investigators (Y. Doi, T. Shiono, R. Mulhaupt, and R. M. Waymouth), and these methods can be summarized as follows:

Y. Doi et al. have reported a method for synthesizing polypropylene with functional end using its living polymerization in the presence of V(acac)₃-AlEtCl, vanadium catalytic system [Makromol. Chem. Rapid Commun., 5, 811(1984); Makromol. Chem. Rapid Commun., 6, 639(1985); Makromol. Chem., 186, 1825(1985); Makromol. Chem., 186, 11(1985); Macromolecules, 14, 814(1979); Makromol. Chem. Rapid Commun., 8, 285(1987); Makromol. Chem., 188, 1273(1987)]. This method is designed to utilize a highly reactive alkyl-vanadium bond at the end of polymer chains for further transformation with an appropriate reagent.

Another method using ZnEt₂ as a chain transfer agent has been disclosed. T. Shiono et al. has disclosed a method for synthesizing polypropylene with functional end in such a manner to convert the functional end of polymer into some polar groups (e.g., a hydroxy group, a carboxylic group, a chloride and bromide) in the presence of an appropriate reagent, when an alkyl-zinc bond, during polymerization of polypropylene, is formed at the end of polymer due to the chain transfer characteristics of ZnEt₂ in a Ziegler-Natta catalytic system such as TiCl₃—AlEt₂ [Macromol. Chem. Phys., 195, 3303(1994); Macromol. Chem. Phys., 195, 1381(1994); Makromol. Chem., 193, 2751(1992); Makromol. Chem. Rapid Commun., 167(1990)].

Another method is to synthesize polypropylene with functional end under β-hydride elimination so as to generate a functional end of polymer in the presence of metallocene catalyst. More typically, since the majority of polypropyrene prepared with metallocene catalysts has a terminal vinylidene group, generated from β-hydride elimination, this method is to introduce a polar functional group to the end of polymer chains by treating such unsaturated vinylidene group with an appropriate reagent. For example, R. Mulhaupt et al. have confirmed that a great number of unsaturated vinylidene and vinyl groups are contained at the end of polypropylene during the rac-Et(H₄Ind)₂ZrCl₂/methylaluminoxane catalyzed polymerization, and that those groups can be transformed into various polar functional groups such as a maleic anhydride group, a hydroxyl group, an amine group, a silane group, and an epoxy group using a various reagents [Macromol. Chem., Macromol. Symp., 48/49,317(1991)].

The similar studies performed by T. Shiono et al. and T. C. Chung have also revealed that polypropylene with a highly reactive functional end can be synthesized via a post-reaction such as hydro-alumination or hydro-boration on the vinylidene groups at the end of polypropylene chains [Macromol. Chem. Rapid Commun., 13, 371(1992); Macromolecules, 25, 3356(1992); Macromolecules, 26, 2085(1993); J. Mole. Cat. A: Chem., 115, 115(1997)].

In spite of the fact that such well-known methods for synthesizing polypropylene with functional end group have been reported to be useful for manufacture of block copolymers, some complicated matters have yet to be solved in that polymerization should be performed at an extremely low temperature or additional post-reaction is necessary using a special reagents after polymerization. Up to now, any successful manufacturing method for large-scale production of polyethylene with functional end group has not been disclosed.

On the other hand, the main examples of the chain transfer reactions reported hitherto include β-hydride elimination (proposed in this reactions are both β-hydride elimination on a central metal of catalyst and β-hydride transfer reaction to monomer), chain transfer to aluminum, and β-methyl elimination. Among these chain transfer reactions, β-hydride elimination is apt to happened major chain transfer reaction in olefin polymerization using most metallocene catalysts but the molecular weight of polyolefin is lower than that of a heterogeneous Ziegler-Natta catalytic system under similar conditions.

The alkyl chain transfer reaction to aluminum has been reported to occur in low frequency in the polyolefin polymerization using most metallocene catalysts except 1,5-hexadiene cyclopolymerization using metallocene catalyst having a ligand of a larger steric hindrance.

The β-methyl elimination, which is absent in the ethylene polymerization, is a special chain transfer reaction, when metallocene catalyst having a ligand of a larger steric hindrance is employed in the polypropylene polymerization.

In general, a heterogeneous Ziegler-Natta catalyst or metallocene catalyst is employed in the olefin polymerization. The metallocene catalyst has drawn a keen attention from the academic and industrial fields in that (1) its polymerization activity is higher than heterogeneous Ziegler-Natta catalyst, (2) its copolymerization capability of comonomer is excellent, and (3) and the molecular structure of the polymer chain can be controlled. This means that the manufacture of a novel polyolefin, which has not been achieved by the conventional Ziegler-Natta catalyst, becomes possible with improved productivity. The current research for the manufacture of polyolefin in the presence of metallocene catalyst has focused on the control of the stereo-specificity and chemical structure of polymers including its molecular weight and distribution as well as the manufacturing technology to introduce polar functional groups to the polyolefin chains.

### SUMMARY OF THE INVENTION

The inventor et al. have studied the chain transfer reactions in the ethylene polymerization using metallocene catalysts, a reaction to terminate polymerization effecting molecular weight, its distribution and the chain end structure of polymers.

As a result, it has been noted that when ethylene is polymerized in the presence of metallocene catalysts, the steric and electronic interactions are generated from a ligand bonded to the central metal of metallocene catalyst and the polymer chains. Then, more chain transfer reactions are induced in such a manner that alkyl group is more frequently and predominantly transferred to aluminum during polymerization, thus obtaining polyethylene homopolymer or copolymer with alkyl-aluminum bond at the end of polymer chains.

Therefore, an object of the present invention is to provide a process for manufacturing polyethylene containing a highly reactive alkyl-aluminum at the end of polymer chain in the predetermined polymerization conditions.

### BRIEF DESCRIPTION OF THE DRAWINGS

FIG. 1a is a ¹H-NMR spectrum of polyethylene with functional end group, so synthesized in Example 1;

FIG. 1b is a ¹³C-NMR spectrum of polyethylene with functional end group, so synthesized in Example 1;

FIG. 2a is a ¹H-NMR spectrum of polyethylene with functional end group, so synthesized in Example 2;

FIG. 2b is a ¹³C-NMR spectrum of polyethylene with functional end group, so synthesized in Example 2.

### DETAILED DESCRIPTION OF THE INVENTION

The present invention is characterized by a process for manufacturing polyethylene with a functional end group represented by the following formula 2, wherein polyethylene represented by the following formula 2 is prepared in such a manner that a functional group (X) is introduced to the end of polyethylene end via selective chain transfer reaction in the presence of metallocene catalysts represented by the following formula 1 and an alkyl-aluminum compound as a chain transfer agent represented by the following formula 3.

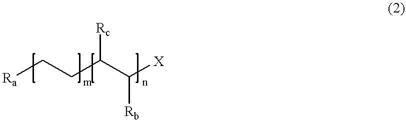

Where, Rₐ is a hydrogen atom or an alkyl group of 1 to 6 carbon atoms;

R_{b} and R_{c} represent a substituent of comonomer polymerized with ethylene, wherein R_{b} is an alkyl-substituent of comonomer consisting of an aliphatic group of 1 to 12 carbon atoms, an aromatic group, and an alicyclic group, while R_{c} represent a hydrogen atom or R_{c} is connected to R_{b} to generate a 5- or 6-membered ring;

m is an integer of 10 to 1,000,000; and,

n is 0 or an integer of 1 to 10,000;

X, which represents a functional group attached to the end of polymer chain, is one of the following groups: an alkyl-aluminum group, a chloride group, a bromide group, an iodide group, a hydroxy group, and a carboxyl group.

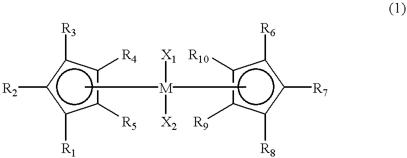

Where, M, R₁, R₂, R₃, R₄, R₅, R₆, R₇, R₈, R₉, R₁₀, X₁, and X₂ are the same as defined above.

Al—(R)₃ (3)

Where, R is an alkyl group of 1 to 4 carbon atoms representing a methyl group, an ethyl group, and an isobutyl group.

The present invention is explained in more detail as set forth hereunder.

The present invention is characterized by the manufacture of polyethylene homopolymer and polyethylene copolymer having a functional end group, respectively, via an easy and economical process.

In case where polyethylene with a functional end group represented by the formula 2 is to be manufactured in the presence of a heterogeneous Ziegler-Natta catalyst, several drawbacks exist in that (1) any homogeneous polymerization such as solution polymerization is impossible, (2) the polymers having less than 3 of molecular weight distribution can't be obtained, and (3) the comonomer content of the copolymers is low.

By contrast, the preparation method of the present invention is that before the polymerization is terminated, a chain transfer reaction induced by aluminum occurs in the presence of a specific metallocene catalyst, thus manufacturing polyethylene represented by the above formula 2 in more easy and economical manner.

The chain transfer reaction of the present invention is based on the experimental results and theoretical studies on the metallocene catalyzed polymerization reactions. Intensive studies have been made on the chain termination reactions that determine the chemical structure at the end of polymer as well as molecular weight of a polymer and its distribution.

Several chain transfer reactions for polymerization of olefin using a metallocene catalyst have been proposed according to the types of catalyst, olefin monomer and the polymerization conditions. Among them, both β-hydride elimination and chain transfer to aluminum are considered as major chain transfer reactions. The β-hydride elimination is regarded as more important and frequently occurring chain transfer reaction.

In the study on the polymerization of ethylene using bis(cyclopentadienyl)zirconium dichloride, a typical metallocene catalyst for ethylene polymerization, J. C. W. Chien reported in 1990 that β-hydride elimination is about 20 times faster than chain transfer to aluminum [J. Polym. Sci., Polym., Chem., 28, 15(1990)].

Thereafter, many researchers have supported the above result through spectroscopic experiment that a vinyl group or a vinylidene group formed via β-hydride elimination is present at the chain end of polyolefin obtained with metallocene catalysts. The predominant occurrence of the β-hydride elimination lies in the fact that since the central metal of metallocene catalyst, an active site of polymerization, bears electronically unstable positive charge, the metal center tends to accept electrons from the outside. In this respect, many experimental and theoretical studies have indicated that positively charged metal center of a metallocene catalyst has a typical β-agostic interaction which coordinates closely carbon-hydrogen bonding electrons between beta-hydrogen and β-carbon in polymer chains. Therefore, an intermediate having β-agostic interaction has been recognized as the most important reaction intermediate during olefin polymerization [TRIP, 2, 158(1994)], and β-hydride elimination [Organometallics, 14, 746(1995); Macromol. Rapid Commun. 18, 715(1997)]. Accordingly, it is certain that β-hydride elimination is induced by β-agostic interaction. If the central metal of catalyst is electronically stabilized by a substituent of cyclopentadienyl ligand and any chain conformation necessary for β-hydride elimination is hinder, it is believed that the occurrence of β-hydride elimination becomes reduced resulting in increase of the molecular weight of polyolefin.

The most important mechanism of the present invention is to hinder the electronic stabilization of central metal induced by the β-agostic interaction through a steric hindrance between the ligand of catalyst and a propagating chain end.

The inventor et al. have completed the present invention for manufacturing polyethylene homopolymer or copolymer with alkyl-aluminum at its chain end, through inhibition of the β-hydride elimination via (1) introducing substituents on the ligands and (2) use of substituted comonomers, providing a larger steric hindrance effect to cyclopentadienyl ligand backbone in metallocene catalyst, thus promoting an alkyl chain transfer to aluminum.

The inhibition of β-agostic interaction is explained in more detail based on the steric hindrance as set forth hereunder.

The possible chain conformation of β-agostic interaction for metallocene complex requires an orbital overlap between σC—H bond orbital of β-hydrogen-β-carbon in a polymer chain and unoccupied d-orbital in the central metal of metallocene. For its possible stereo-chemistry, α-carbon, β-carbon and β-hydrogen must be located, together with the central metal, on the same plane as the equatorial plane between two cyclopentadienyl ligands of metallocene catalyst. Now that the β-carbon connects β-hydrogen, a polymeric chain and an α-olefin substituent, the polymeric chain and α-olefin substituent bonded on the β-carbon are located perpendicular to the equatorial plane as well as α-carbon and β-hydrogen located on the same plane as the equatorial plane. Cyclopentadienyl ligands with less steric hindrance favor the above chain conformation of β-agostic interaction and β-hydride elimination, thus a vinyl or vinylidene group is easily formed at chain end of polyethylene. In contrast, since metallocene catalyst with complicatedly substituted cyclopentadienyl ligands shows a larger steric hindrance effect due to the presence of many substituents, it is subject to a larger steric hindrance when the chain is arranged depending on the β-agostic interaction and then, β-hydride elimination is inhibited due to thermodynamically high energy state.

The central metal of catalyst in the absence of such β-agostic interaction becomes unstable. Under such circumstances, the chain transfer reaction which does not require the above chain conformation is promoted via alkyl transfer to aluminum. As a result, the chain transfer to aluminum becomes a predominant chain transfer reaction instead of β-hydride elimination in the metallocene-catalyzed polymerization and a highly reactive alkyl-aluminum group is formed at the end of polymer chains. In consequence, polyethylene with a highly reactive end group becomes available using a common polymerization process without additional post-reaction.

The control of the molecular structure of polymers can be effectively made through the changes of the ligand structure of metallocene catalyst and the substituent of comonomer as well as other controlling factors including concentration of comonomer, polymerization temperature, and concentration and composition of alkyl-aluminum group as chain transfer agent.

According to this invention, the synthesis method is explained as set forth hereunder.

According to this invention, the polymerization process for manufacturing polyethylene with functional end group represented by the formula 2 can be performed in the presence of a catalytic system consisting of metallocene catalyst with one and more cyclopentadienyl backbones, more favorably with two cyclopentadienyl backbones, plus a cocatalyst containing an alkyl-aluminum compound as active ingredient, in the form of solution and slurry polymerization using solvent such as toluene under an oxygen- and moisture-free polymerization system, or mass polymerization using monomer itself as solvent.

The cocatalyst should contain an alkyl-aluminum compound represented by the formula 3 as active ingredient. One and more cocatalysts for olefin polymerization can be selected from other well-known cocatalysts of metallocene catalyst; among them, it is preferred to use methylaluminoxane compound and an organic borate compound for obtaining polymer with an appropriate polymerization activity and molecular weight.

According to this invention, the process for manufacturing polyethylene with functional end group is explained in more detail as set forth hereunder.

The oxygen- and moisture-free solvent is placed in a deoxygenated and dehydrated reactor. Then, a single alkyl-aluminum compound or its mixture with methylaluminoxane compound or an organic borate compound is added to the reactor, while introducing ethylene and α-olefin as polymerization monomer, if deemed necessary.

With the addition of polymerization catalyst used for the present invention, polymerization is performed at appropriate temperature and time, followed by infusion of drying air into this polymer solution to oxidize aluminum-alkyl group at the end of each polymer chain. After the reaction is completed, the reaction mixture was placed into acidic methanol solution, and the polymer was separated and washed. The product is dried in vacuum.

According to this invention, polyethylene with alkyl-aluminum at the chain end can be converted to polyethylene with halogen or carboxyl group at the chain end via the conventional halogenation and reaction with carbon dioxide [Makromol. Chem., Rapid Commun., 13,371(1992): Makromol., Chem., 193, 2751 (1992)].

According to the present invention, the a-olefin monomer, which is used for copolymerization of polyethylene represented by the formula 2, may be selected from all α-olefin monomers. One or more of α-olefin monomers may be selected for polymerization from the group consisting of propylene, 1-butene, 1-pentene, 1-hexene, 3-methyl-1-pentene, 1-octene, 1-decene, cyclopentene, norbornene, 5-vinyl-2-norbornene, 1,4-hexadiene, 5-methyl-1,4-hexadiene, 5-methyl-1,5-heptadiene, 6-methyl-1,7-octadiene, 7-methyl-1,6-octadiene, styrene, divinylbenzene, and allylbenzene. Comonomers rather sterically hindered by cyclopentadienyl derivatives of the catalyst at the state of chain conformation required for β-agostic interaction can be used more effectively in the present invention.

Further, the catalytic system used for the present invention may include all of already known metallocene catalysts for olefin polymerization. Hence, the preparation of the polyethylene can be maximized in the presence of a metallocene compound containing two cyclopentadienyl-derived ligands of more than two substituents, represented by the formula 1, together with a cocatalyst containing a large amount of the alkyl-aluminum compound as active ingredients.

The typical examples of metallocene catalysts represented by the formula 1 includes the following compounds:

Bis(dimethylcyclopentadienyl)zirconium dichloride,

Bis(trimethylcyclopentadienyl)zirconium dichloride,

Bis(tetramethylcyclopentadienyl)zirconium dichloride,

Bis(pentamethylcyclopentadienyl)zirconium dichloride,

Bis(methylethylcyclopentadienyl)zirconium dichloride,

Bis(diethylcyclopentadienyl)zirconium dichloride,

Bis(triethylcyclopentadienyl)zirconium dichloride,

Bis(dibutylcyclopentadienyl)zirconium dichloride

Bis(indenyl)zirconium dichloride,

Bis(methylindenyl)zirconium dichloride,

Bis(dimethylindenyl)zirconium dichloride,

Bis(trimethylindenyl)zirconium dichloride,

Bis(4,5,6,7-tetrahydroindenyl)zirconium dichloride,

Ethylenebis(methylcyclopentadienyl)zirconium dichloride,

Ethylenebis(dimethylcyclopentadienyl)zirconium dichloride,

Ethylenebis(trimethylcyclopentadienyl)zirconium dichloride,

Ethylenebis(indenyl)zirconium dichloride,

Ethylenebis(methylindenyl)zirconium dichloride,

Ethylenebis(dimethylindenyl)zirconium dichloride,

Ethylenebis(4,5,6,7-tetrahydroindenyl)zirconium dichloride,

Dimethylsilylenebis(methylcyclopentadienyl)zirconium dichloride,

Dimethylsilylenebis(dimethylcyclopentadienyl)zirconium dichloride,

Dimethylsilylenebis(trimethylcyclopentadienyl)zirconium dichloride,

Dimethylsilylenebis(indenyl)zirconium dichloride,

Dimethylsilylenebis(methylindenyl)zirconium dichloride,

Dimethylsilylenebis(dimethylindenyl)zirconium dichloride

Dimethylsilylenebis(4,5,6,7-tetrahydroindenyl)zirconium dichloride.

From the above compounds, zirconium may be replaced by transition metal atoms selected from Group IVB of the periodic table such as titanium and hafnium. Further, dichloride may be also replaced by methylchloride, dimethyl, and dimethylamine.

According to the present invention, zirconium or titanium is preferred as a central metal atom in the catalytic system of metallocene represented by the formula 1. Hence, it is preferred to use the metallocene catalyst containing one or more cyclopentadienyl backbones of at least two substituents as ligand, more preferably two cyclopentadienyl backbones.

The metallocene catalyst useful in the present invention can be prepared by the method known in the prior arts.

The catalytic system consists of metallocene represented by the above formula 1 as a catalyst and a cocatalyst. The cocatalyst may include an alkyl-aluminum compound represented by the above formula 3, methylaluminoxane compound, organic borate compound, or its mixture. In case where the alkyl-aluminum compound represented by the formula 3 as a cocatalyst is used in combination with methylaluminoxane compound, alkyl-aluminum compound can be employed as any remaining alkyl-aluminum compounds or other additional composition regardless of manufacturing process for methylaluminoxane. Therefore, the examples of the cocatalyst include the alkyl-aluminum compound, methylaluminoxane compound containing the alkyl-aluminum compound, or an organic borate compound containing the alkyl-aluminum compound.

The examples of methylaluminoxane compound, which is employed as a cocatalyst together with the alkyl-aluminum compound, include a cyclic compound represented as —(—R—Al-0)ₙ—, a linear compound as R—(—R—Al-0-)ₙ—AlR₂, or a cluster (where, R is an alkyl group of 1 to 5 carbon atoms and n is a integer of 1 to 20). Further, one and more of alkyl-aluminum compound may be contained for an optimal polymerization in the manufacturing process.

The methylaluminoxane compound can be prepared by the method known in the prior arts. Generally, such compound is prepared in a mixture of a cyclic or a linear compound, or a cluster and an unreacted alkyl-aluminum compound. According to this invention, an alkyl-aluminum compound such as trimethylaluminum can be added to methylaluminoxane compound

The organic borate compound, a cocatalyst, is represented as (R′)₄—B—R″, (where, R′ is an aromatic fluoride group such as pentafluorophenyl, and R″ is a counter-ion a such as a quaternary ammonium salt or stable carbocation). According to this invention, an alkyl-aluminum compound such as trimethylaluminum can be added to the organic borate compound.

As described above, the compounds such as methylaluminoxane compound and an organic borate compound can be employed as a cocatalyst for this invention, but any polymerization should be performed in the presence of the alkyl-aluminum compound as an other cocatalyst or a chain transfer agent.

The alkyl-aluminum compound, which is used directly as a chain transfer agent or as one component of other cocatalyst, is added to 1 mole of metallocene catalyst in the range of 100 to 100,000 mole. If the alkyl-aluminum compound represented by the formula 3 is added to metallocene catalyst in less amount than the above range, the chain transfer reaction to aluminum insufficiently occurs. In case of exceeding the above range, a polymer will have an extremely low molecular weight with extremely poor polymerization activity, even though the transfer reaction from alkyl to aluminum is effectively performed.

The above catalytic system may be used as a supported catalyst system for this invention.

In case where polyethylene copolymer is to be prepared in the presence of the catalytic system, most of common polymerization conditions related to copolymerization of ethylene and ethylene-α-olefin shall apply. According to the present invention, the chain transfer reaction is modulated by changes in catalyst, especially depending mainly on the structure and number of substituents of cyclopentadienyl backbone as ligand in catalyst. If the number of substituents is larger, more significant effects in polymerization can be expected.

Further, when ethylene is copolymerized with alpha-olefin comonomer, the steric hindrance of alpha-olefin is also important. A larger substituent of alpha-olefin, which has a larger steric hindrance with the catalyst ligand, is capable of inducing an effective alkyl chain transfer reaction to aluminum.

As well understood in homopolymerization of ethylene, it is quite effective in this invention that substituent-free monomer is polymerized with the metallocene catalyst of the bulky cyclopentadienyl ligand having many substituents. By contrast, metallocene catalyst containing cyclopentadienyl backbone with a few substituents can be effectively used in copolymerization using some α-olefin monomer having bulky substituents, which can induce a very high steric hindrance. In either case, a higher concentration of catalyst is effective in polymerization; in particular, the addition of alkyl-aluminum compound such as trimethylaluminum or triethylaluminum into the cocatalyst system is most preferred.

According to the present invention, polyethylene with functional end group represented by the formula 2 has a homopolymer or copolymer structure. The various reactive groups can be introduced to the alkyl-aluminum group of the polyethylene a variety of well-known organic reactions. Polyethylene, so prepared from the present information, may be used as a macromonomer for block or graft copolymerization.

The present invention is explained in more detail based on the following Examples but is not confined to these Examples which are only designed to help understand the present invention.

To identify the polymerization structure of polyethylene polymer with functional end group, so prepared from the following Examples of the present invention, the masses of polymer were accurately weighed and then nuclear magnetic resonance (NMR) analysis was performed for analysis of polymer structure, while gel permeation chromatography (GPC) was performed for analysis of its molecular weight.

¹H-NMR and ¹³C-NMR were performed by a nuclear magnetic resonance spectrometer (500MHz) at 110° C. in the presence of tetrachloroetane-d₂ as solvent, while GPC was performed by high temperature gel chromatography at 135° C. in the presence of 1,2,4-trichlorobenzene as solvent based on the polystyrene standard.

### EXAMPLE 1

A 100 ml flask equipped with Schlenk tube was attached to a thermostat adjusted at room temperature. The gas in the flask was replaced by oxygen- and moisture-free ethylene gas using Schlenk tube at room temperature, followed by the addition of 41 ml of purified toluene. Then, 4 ml of methylaluminoxane-toluene solution (5 mmol of aluminum content) containing 41 mol % of free trimethylaluminum was added and stirred. After the reactor was installed in the thermostat, the temperature of polymerization solution in the flask was adjusted at 80° C. With the feeding of ethylene gas under the constant pressure of 1.2 bar, polymerization was initiated with the addition of 5 ml of 2.5 μmol bis(pentamethylcyclopentadienyl)zirconium dichloride-toluene solution. After one-hour polymerization, the feeding of ethylene gas was discontinued. With the temperature of polymerization solution adjusted at 60° C., a small amount of dry air, so passed through a drying filter, was introduced to the reactor. The reactor temperature was cooled to room temperature, while flowing the dry air into the reactor for two hours. The reaction mixture was infused to an acidic methanol solution for precipitation. The precipitate was left overnight, filtered off by a membrane filter and washed with pure methanol several times. Then, the reactant was dried in the vacuum oven at 50° C. to obtain 0.9 g of polyethylene with terminal hydroxyl group.

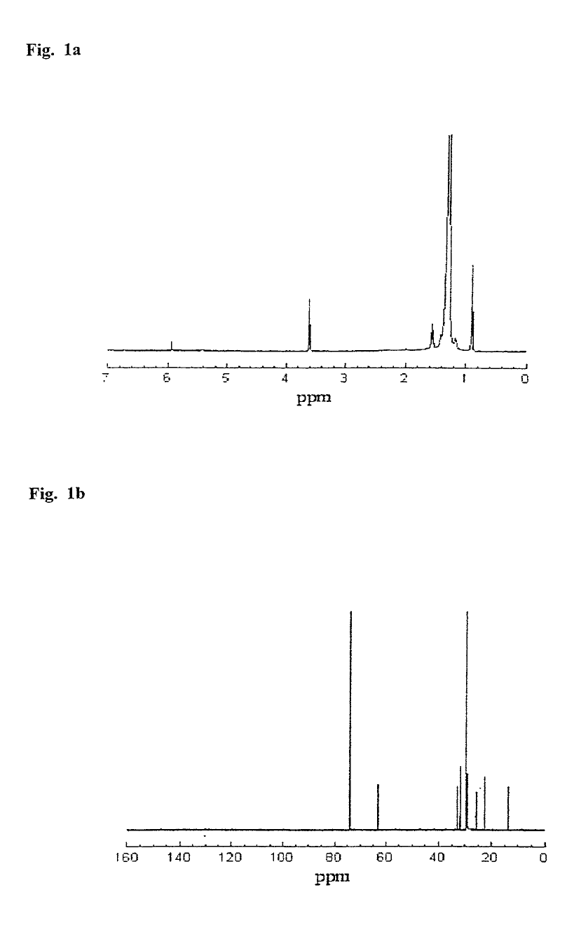

¹H-NMR and ¹³C-NMR spectra of the polymer, so formed, were observed at 110° C. using tetrachloroethane-d₂ as an analysis solvent, as shown in the attached FIG. 1a and 1b.

From FIG. 1a, it was revealed that polyethylene polymer with terminal hydroxyl groups was prepared with the following results: main peak at 1.3 ppm by hydrogen nuclei in ethylene alkyl backbone, triplet peak at 0.9 ppm by hydrogen nuclei in terminal methyl groups, triplet peak at 3.6 ppm by hydrogen nuclei in methylene groups adjacent to terminal hydroxyl groups, triplet peak at 1.6 ppm by hydrogen nuclei in methylene groups of β-carbon position to terminal hydroxy groups, plus solvent peak of 5.94 ppm, when tetrachloroethane-d₂ was used as an analysis solvent.

From FIG. 1b, it was also revealed that polyethylene polymer with terminal hydroxyl groups was prepared with the following results: main peak at 29.6 ppm by carbon nuclei in ethylene alkyl backbone, peak at 13.8 ppm by carbon nuclei in terminal methyl groups, peak at 22.5 ppm by carbon nuclei in methylene groups adjacent to terminal hydroxyl groups, peak at 33.0 ppm by carbon nuclei in methylene groups of β-carbon position to terminal hydroxy groups, plus solvent peak at 74.0 ppm, when tetrachloroethane-d₂ was used as an analysis solvent.

The results of GPC analysis on this copolymer, so formed, showed that its weight average molecular weight was 2,000 daltons, while the polydispersity was 1.3.

The formation ratio of functional end group calculated from ¹H-NMR analysis of polyethylene polymer or copolymer was calculated by quantitative analysis of all the end groups formed from each chain transfer reaction. More specifically, the end groups were a methylene group adjacent to terminal hydroxyl group at 3.5˜3.7 ppm and an unsaturated group such as vinylidene, trans-vinylene, and vinyl group observed typically between 4.7˜5.5 ppm. These unsaturated bond groups were derived from various β-hydride elimination, while the terminal hydroxyl group was derived from the oxidation of alkyl-aluminum end group formed via chain transfer to aluminum. Therefore the formation ratio of terminal hydroxyl group is calculated by the following equation 1.

Formation ratio of terminal hydroxy group (mol %)=(A_{3.6})/[{(A₃₆)+(A_{5.0})}]×100 Equation 1

Where, A_{3.6} is the nuclear magnetic resonance peak area of methylene hydrogen atoms adjacent to terminal hydroxyl group observed at 3.5˜3.7 ppm; A_{5.0} is the nuclear magnetic resonance peak of hydrogen atoms containing all of three structures of the unsaturated bond groups observed between 4.5˜5.6 ppm.

Formation ratio of terminal hydroxy group of Example 1 obtained from the above equation 1 was 98.5 mol %.

### EXAMPLE 2

In the same manner as Example 1, the gas in a flask of Example 1 was replaced by oxygen- and moisture-free ethylene gas, followed by the addition of 31 ml of purified toluene was added. 2 ml of methylaluminoxane-toluene solution (2.5 mmol aluminum content) containing 41 mol % of free trimethylaluminum was added to the toluene and stirred. Then, 4 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 6.4 ml of 2.5 μmol ethylenebis(indenyl)zirconium dichloride-toluene solution. After one-hour polymerization, the feeding of ethylene gas was discontinued. After the temperature of polymerization solution was readjusted to 60° C., the reaction mixture was oxidized and post-treated in the same manner as Example 1, thus obtaining 2.5 g of an ethylene-allylbenzene copolymer with terminal hydroxyl group.

¹H-NMR and ¹³C-NMR spectra obtained from NMR analysis represented in the attached 2a and 2b in the same manner as Example 1.

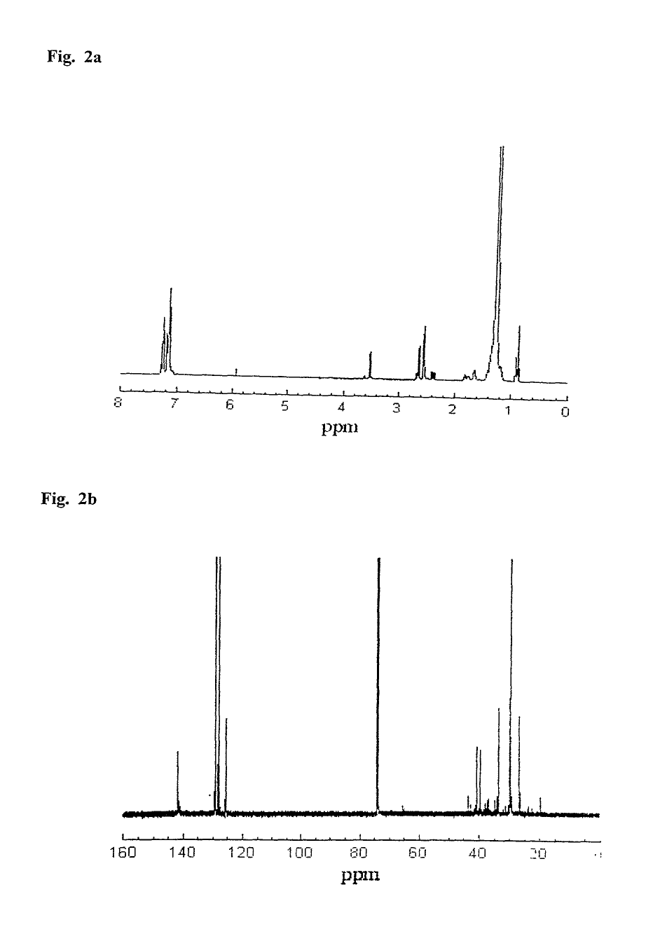

From FIG. 2a, it was revealed that ethylene-allylbenzene copolymer with terminal hydroxyl groups was prepared with the following results: main peak at 1.3 ppm by hydrogen nuclei in ethylene alkyl backbone, peak at 0.9 ppm by hydrogen nuclei in terminal methyl groups, peak at 3.5 ppm by hydrogen nuclei in methylene groups adjacent to terminal hydroxyl groups, peak at 7.2 ppm by phenyl-ringed hydrogen nuclei in allylbenzene unit, peak at 2.6 ppm by benzyl hydrogen nuclei in allylbenzene unit, plus solvent peak of 5.94 ppm, when tetrachloroethane-d₂ was used as an analysis solvent.

From FIG. 2b, it was also revealed that ethylene-allylbenzene copolymer with terminal hydroxyl groups was prepared by the following results: main peak at 29.6 ppm by carbon nuclei in ethylene alkyl backbone, peak of 19.5 ppm by carbon nuclei in terminal benzylmethyl groups, peaks at 65.3 ppm and 63.0 ppm by carbon nuclei in methyl groups adjacent to terminal hydroxyl groups, peaks at 125.5, 128.1, 129.2 and 141.9 ppm by phenyl-ringed carbon nuclei in allylbenzene unit, peak at 41.0 ppm by benzyl carbon nuclei and peak at 39.7 ppm of methyn carbon nuclei in allylbenzene unit, plus solvent peak of 39.7 ppm, when tetrachloroethane-d₂ was used as an analysis solvent.

The results of GPC analysis on this copolymer, so formed, showed that its weight average molecular weight was 4,200 daltons, while the polydispersity was 1.3.

The formation ratio of terminal hydroxy group measured by ¹H-NMR analysis of this copolymer based on the equation 1 was 98.3 mol %. Further, the incorporation content of allylbenzene in the copolymerization can be calculated based on the following equation 2 from the peak area ratio of phenyl ring of allylbenzene and ethylene backbone measured from ¹H-NMR analysis.

Copolymerization participating ratio of allylbenzene Equation 2

$$( mol \% ) = [ \frac{( {A}_{7.2} / 5 )}{( {A}_{7.2} / 5 ) + \frac{{A}_{1.3} - 2 ( {A}_{7.2} / 5 )}{4}} ] \times 100$$

Where, A_{7.2} is the nuclear magnetic resonance peak area of phenyl-ring hydrogen atoms observed at 7.0˜7.5 ppm in allylbenzene unit; A_{1.3} is the nuclear magnetic resonance peak area of hydrogen atoms observed between 1.05˜1.55 ppm in the ethylene backbone.

The incorporation content of allylbenzene calculated from the above equation 2 was 9.6 mol %.

### EXAMPLE 3

In the same manner as Example 1, the gas in a flask of Example 1 was replaced by oxygen- and moisture-free ethylene gas, followed by them addition of 39 ml of purified toluene was added. 2 ml of methylaluminoxane-toluene solution (2.5 mmol aluminum content) containing 41 mol % of free trimethylaluminum was added to the toluene and stirred. Then, 2.5 ml of trimethylaluminum-toluene solution (5 mmol aluminum content) was added to the reaction mixture and then 4 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 2.5 ml of 2.5 μmol ethylenebis(indenyl)zirconium dichloride-toluene solution. After one-hour polymerization, the feeding of ethylene gas feeding was discontinued. In the same manner as Example 1, the reaction mixture was oxidized and post-treated to obtain 4.1 g of an ethylene-allylbenzene copolymer with terminal hydroxyl group.

The results of GPC analysis on this copolymer, so formed, showed that its weight average molecular weight was 5,900 daltons, while the polydispersity was 1.4. Further, when the peak area ratio of each end group measured from ¹H-NMR analysis was applied to the above equation 1, the formation ratio of terminal hydroxy group in the copolymer was 96.2 mol %.

### EXAMPLE 4

In the same manner as Example 1, the gas in a flask of Example 1 was replaced by oxygen- and moisture-free ethylene gas, followed by the addition of 33 ml of purified toluene was added. 4 ml of methylaluminoxane-toluene solution (5 mmol aluminum content) containing 41 mol % of free trimethylaluminum was added to the toluene and stirred. Then, 6.6 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 6.4 ml of 2.5 μmol bis(2-methylindenyl)zirconium dichloride-toluene solution. After one-hour polymerization, the feeding of ethylene gas was discontinued. After the temperature of polymerization solution was readjusted to 60° C., the reaction mixture was oxidized and post-treated in the same manner as Example 1, thus obtaining 0.9 g of an ethylene-allylbenzene copolymer with terminal hydroxyl group.

The results of GPC analysis on this copolymer, so formed, showed that its weight average molecular weight was 13,000 daltons, while the polydispersity was 2.1. Further, when the peak area-ratio of each end group measured from ¹H-NMR analysis was applied to the above equation 1, the formation of terminal hydroxy group in the copolymer was 94.0 mol %.

### EXAMPLE 5

In the same manner as Example 1, the gas in a flask of Example 1 was replaced by oxygen- and moisture-free ethylene gas, followed by the addition of 35 ml of purified toluene was added. 4 ml of methylaluminoxane-toluene solution (5 mmol aluminum content) containing 41 mol % of free trimethylaluminum was added to the toluene and stirred. Then, 6.6 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 4.4 ml of 2.5 μmol bis(pentamethylcyclopentadienyl)zirconium dichloride-toluene solution. After one-hour polymerization, the feeding of ethylene gas feeding was discontinued. After one-hour polymerization, the feeding of ethylene gas was discontinued. In the same manner as Example 1, the reaction mixture was oxidized and post-treated to obtain 2.5 g of an ethylene-allylbenzene copolymer with terminal hydroxyl group.

The results of GPC analysis on this copolymer, so formed, showed that its weight average molecular weight was 5,700 daltons, while the polydispersity was 1.5. Further, when the peak area ratio of each end group measured from ¹H-NMR analysis was applied to the above equation 1, the formation ratio of terminal hydroxy group in the copolymer was 98.6 mol %.

### EXAMPLE 6

In the same manner as Example 1, the gas in a flask of Example 1 was replaced by oxygen- and moisture-free ethylene gas, followed by the addition of 36 ml of purified toluene was added. 4 ml of methylaluminoxane-toluene solution (5 mmol aluminum content) containing 41 mol % of free trimethylaluminum was added to the toluene and stirred. Then, 6.6 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 3.4 ml of 2.5 μmol dimethylsilylenebis(indenyl)zirconium dichloride-toluene solution. After one-hour polymerization, the feeding of ethylene gas was discontinued. In the same manner as Example 1, the reaction mixture was oxidized and post-treated to obtain 0.9 g of an ethylene-allylbenzene copolymer with terminal hydroxyl group.

The results of GPC analysis on this copolymer, so formed, showed that its weight average molecular weight was 6,700 daltons, while the polydispersity was 1.6. Further, when the peak area ratio of each end group measured from ¹H-NMR analysis was applied to the above equation 1, the formation ratio of terminal hydroxy group in the copolymer was 99.2 mol %.

### EXAMPLE 7

In the same manner as Example 1, the gas in a flask of Example 1 was replaced by oxygen- and moisture-free ethylene gas, followed by the addition of 33 ml of purified toluene was added. 4 ml of methylaluminoxane-toluene solution (5 mmol aluminum content) containing 41 mol % of free trimethylaluminum was added to the toluene and stirred. Then, 6.6 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 6.4 ml of 2.5 μmol ethylenebis(indenyl)zirconium dichloride-toluene solution. After one-hour polymerization, the feeding of ethylene gas was discontinued. In the same manner as Example 1, the reaction mixture was oxidized and post-treated to obtain 6.5 g of an ethylene-allylbenzene copolymer with terminal hydroxyl group.

The results of GPC analysis on this copolymer, so formed, showed that its weight average molecular weight was 6,100 daltons, while the polydispersity was 1.5. Further, when the peak area ratio of each end group measured from ¹H-NMR analysis was applied to the above equation 1, the formation ratio of terminal hydroxy group in the copolymer was 95.2 mol %.

### EXAMPLE 8

In the same manner as Example 1, the gas in a flask of Example 1 was replaced by oxygen- and moisture-free ethylene gas, followed by the addition of 38 ml of purified toluene was added. Then, 1.6 ml of purified 1-octene was added to the solution. After a reactor was installed in the thermostat, the temperature of polymerization solution in the flask was adjusted to 80° C. 5 ml of toluene solution dissolved in trimethylaluminum having 2.5 mmol aluminum content and 2.5 μmol bis(pentamethylcyclopentadienyl)zirconium dichloride was added and stirred. With the feeding of ethylene gas under the constant pressure of 1.2 bar, polymerization was initiated in a reactor with the addition of 5.4 ml of toluene solution dissolved in 2.5 μmol of quaternary fluorophenyl borate salt (Ph₃CB(C₆F₅)₄). After one-hour polymerization, the feeding of ethylene gas was discontinued. In the same manner as Example 1, the reaction mixture was oxidized and post-treated to obtain 0.3 g of an ethylene-1-octene copolymer with terminal hydroxyl group.

The results of GPC analysis on this copolymer, so formed, showed that its weight average molecular weight was 4,100 daltons, while the polydispersity was 1.4. Further, when the peak area ratio of each end group measured from ¹H-NMR analysis was applied to the above equation 1, the formation ratio of terminal hydroxy group in the copolymer was 91.3 mol %.

### Comparative Example 1

In the same manner as Example 1, the gas in a flask of Example 1 was replaced by oxygen- and moisture-free ethylene gas, followed by the addition of 39.6 ml of purified toluene was added. After a reactor was installed in the thermostat, the temperature of polymerization solution in the flask was adjusted to 80° C. 5 ml of toluene solution dissolved in triisobuthylaluminum having 25 μmol aluminum content and 2.5 μmol bis(cyclopentadienyl)zirconium dichloride was added and stirred. With the feeding of ethylene gas under the constant pressure of 1.2 bar, polymerization was initiated in a reactor with the addition of 5.4 ml of toluene solution dissolved in 2.5 μmol of quaternary fluorophenyl borate salt (Ph₃CB(C₆F₅)₄). After one-hour polymerization, the feeding of ethylene gas was discontinued. In the same manner as Example 1, the reaction mixture was oxidized and post-treated to obtain 0.5 g of polyethylene polymer with terminal unsaturated group.

The results of GPC analysis on this copolymer, so formed, showed that its weight average molecular weight was 48,000 daltons, while the polydispersity was 3.2. Further, when the peak area ratio of each end group measured from ¹H-NMR analysis was applied to the above equation 1, the formation ratio of terminal hydroxy group in the copolymer was 0.9 mol %.

### Comparative Example 2

In the same manner as Example 1, the gas in a flask of Example 1 was replaced by oxygen- and moisture-free ethylene gas, followed by the addition of 36 ml of purified toluene was added. 4 ml of methylaluminoxane-toluene solution (5 mmol aluminum content) containing 41 mol % of free trimethylaluminum was added to the toluene and stirred. Then, 6.6 ml of purified allylbenzene was added to the mixture. After a reactor was installed in the thermostat, the temperature of polymerization solution in the flask was adjusted to 80° C. With the feeding of ethylene gas under the constant pressure of 1.2 bar, polymerization was initiated in a reactor with the addition of 3.4 ml of 2.5 μmol bis(cyclopentadenyl)zirconium dichloride-toluene solution. After one-hour polymerization, the feeding of ethylene gas was discontinued. In the same manner as Example 1, the reaction mixture was oxidized and post-treated to obtain 3.3 g of an ethylene-allylbenzene copolymer with unsaturated terminal group.

The results of GPC analysis on this copolymer, so formed, showed that its weight average molecular weight was 4,600 daltons, while the polydispersity was 1.3. Further, when the peak area ratio of each end group measured from ¹H-NMR analysis was applied to the above equation 1, the formation ratio of terminal hydroxy group in the copolymer was 29.7 mol %.

The above Examples 1˜8 of the present invention relate to the methods using the specific metallocene catalysts and cocatalyst containing alkyl-aluminum compound as a chain transfer agent. According to these methods, the polymerization designed to generate the end functional group in polymer is primarily made available towards alkyl chain transfer to aluminum. As a result, the narrow scope of molecular weight in polymer, so formed, ensures the narrow molecular weight distribution. In addition, from the copolymerization with comonomers having a larger steric hindrance, the copolymer of this invention has a very high incorporation content. As described above, it is well understood that an ethylene homopolymer or copolymer with functional end group can be prepared without additional post reaction.

According to the present invention, some polar functional groups including hydroxyl group (e.g., carboxylic group, chloride, fluoride and iodide) can be introduced to the end group of polymer with the addition of carbon-dioxide, chlorine, fluorine, and iodine instead of air. The catalytic system of transition metal such as titanium- or hafnium-based metallocene catalytic system including zirconium metallocene catalyst is useful in the present invention. In addition, various results may be obtained depending on polymerization temperature, kinds and concentration of comonomer, solvent, kinds and concentration of catalyst/cocatalyst, catalyst supports.

As described above, the polyethylene process of the present invention using metallocene catalyst is to utilize a novel selective chain transfer reaction so as to functionalize the end group of polymer without additional post-reaction.

Further, polyethylene with a functional end group according to the present invention has several advantages in that (1) the polyethylene of the present invention can be effectively used as a macromolecule for manufacturing block or graft copolymer using appropriate polymerization, (2) the polyethylene of the present invention can be used as an modified polymer of hydrophobic polyethylene for its various properties (e.g., compatability, painting, emulsification, and adhesion), and (3) the polyethylene of the present invention can be used as an intermediate for manufacturing a functional polyethylene with excellent combination of properties based on the introduction of various functional groups to the end of polymer through an appropriate organic reaction.

What is claimed is:

1. A process for manufacturing polyethylene with functional end group represented by the following formula 2, wherein it comprises: polyethylene with terminal alkyl-aluminum group is prepared via selective chain transfer reaction in the catalytic system consisting of metallocene represented by the following formula 1 as a main catalyst and a cocatalyst containing an alkyl-aluminum compound represented by the following formula 3: a functional end group (X) is introduced to polyethylene using the polyethylene with terminal alkyl-aluminum group: 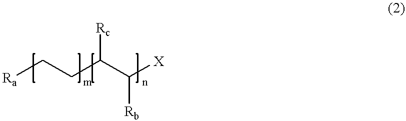
Where, Rₐ, is a hydrogen atom or an alkyl group of 1 to 6 carbon atoms; R_{b} and R_{c} represent an alkyl-substituent structure of comonomer copolymerized with ethylene, wherein R_{b} is a substituent from comonomer structure consisting of an aliphatic group of 1 to 12 carbon atoms, an aromatic group, and an alicyclic group, while R_{c} represent a hydrogen atom or R_{c} is connected to R_{b} to generate a 5- or 6-membered ring;
m is an integer of 10 to 1,000,000; and,
n is 0 or an integer of 1 to 10,000;
X, which represents a functional group attached to the end of polymer, is one of the following groups: an alkyl-aluminum group, a chloride group, a bromide group, an iodide group, a hydroxy group, and a carboxyl group. 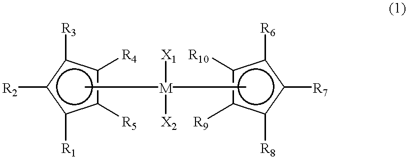
Where, M is a transition metal atom selected from Group IVB of the periodic table; R₁, R₂, R₃, R₄, R₅, R₆, R₇, R₈, R₉ and R₁₀, which are same or different, are a hydrogen atom or an alkyl group of 1 to 12 carbon atoms; at least two substituents should contain an alkyl group of 1 to 12 carbon atoms instead of a hydrogen atom; one or more substituents may be combined each other; X₁ and X₂, which are same or different, are a ligand except for a non-cyclopentadienyl ligand, representing such as an alkyl group of 1 to 12 carbon atoms, an alkoxy group of 1 to 6 carbon atoms, an amine group, a halogen atom, or a hydrogen atom.
Al—(R)₃ (3)
Where, R is an alkyl group of 1 to 4 carbon atoms.

2. The process for manufacturing polyethylene with functional end group according to claim 1, wherein the alkyl-aluminum compound represented by the above formula 3 is used as said cocatalyst independently or as a mixture containing one and more compounds selected from methylaluminoxane compound and organic borate compound.

3. The process for manufacturing polyethylene with functional end group according to claim 2, wherein the definition “a mixture containing one and more compounds selected from methylaluminoxane compound and organic borate compound” means their individual separate addition and mixing regardless of composition in the manufacturing process, or a mixture contained in methylaluminoxane compound as unreacted compounds during reaction.

4. The process for manufacturing polyethylene with functional end group according to claim 2 or 3, wherein said alkyl-aluminum compound represented by the formula 3 is employed in the range of 100˜100,000 mol per 1 mole of metallocene catalyst.

5. The process for manufacturing polyethylene with functional end group according to claim 2 or 3, wherein said methylaluminoxane compound is a cyclic compound represented by —(—R—Al-0)ₙ—, linear compound by R—(—R—Al-0-)ₙ—AlR₂, or a cluster (where, R is an alkyl group of 1 to 4 carbon atoms and n is a integer of 1 to 20).

6. The process for manufacturing polyethylene with functional end group according to claim 2, wherein said organic borate compound is a compound represented by (R′)₄—B—R″ (where, R′ is pentafluorophenyl group, R″ is a counter-ion such as quaternary ammonium salt or stable carbocation).

7. The process for manufacturing polyethylene with functional end group according to claim 1, wherein said polyethylene with the functional end group is a homopolymer or copolymer having a polydispersity of 1 to 5.

8. The process for manufacturing polyethylene with functional end group according to claim 7, wherein said polyethylene copolymer from comonomer, which can polymerize with ethylene as comonomer, is prepared by selecting the group consisting of propylene, 1-butene, 1-pentene, 1-hexene, 3-methyl-1-pentene, 1-octene, 1-decene, cyclopentene, norbornene, 5-vinyl-2-norbornene, 1,4-hexadiene, 5-methyl-1,4-hexadiene, 5-methyl-1,5-heptadiene, 6-methyl-1,7-octadiene, 7-methyl-1,6-octadiene, styrene, divinylbenzene, and allylbenzene.
